(19) United States
(12) Patent Application Publication
(10) Pub. No.: US 2011/0062209 A1
(43) Pub. Date: Mar. 17, 2011

(54) FIXING TOOL WITH A FLEXIBLE BLADE SENSOR

(75) Inventors: Emmanuel Vallon, Portes Les Valence (FR); Patrick Herelier, Saint Jean De Muzols (FR); Frederic Nayrac, Bourg Les Valence (FR)

(73) Assignee: SOCIETE DE PROSPECTION ET D'INVENTIONS TECHNIQUES SPIT, Bourg Les Valence (FR)

(21) Appl. No.: 12/993,162

(22) PCT Filed: May 22, 2009
(86) PCT No.: PCT/IB2009/052156

§ 371 Date: Nov. 17, 2010

(30) Foreign Application Priority Data
May 26, 2008 (FR) 0802836

(51) Int. Cl. B25C 1/00

(52) U.S. Cl. 227/110

(57) ABSTRACT

A fixing tool including a nose adapted to receive, on the one hand, a fixing element from a fixing element magazine fixed to the nose and, on the other hand, a fixing element driving piston, propelled by an energy source, a sensor for operating the tool being arranged on the nose, wherein the sensor includes a flexible blade arranged on a biasing pad.

This invention relates to a fixing tool for driving fixing elements, such as nails and, in such a case, this will be referred to as a nailing device, for fixing parts to a support material. There is contemplated, here, for example, fixing pre-perforated metal sheet plates on framework purlins.

With pre-perforated parts, tools are used, being provided with a positioning sensor placed in the hole before shooting and which, after shooting, is withdrawn under the action of the nail.

Incidentally, the tools to be considered here are tools operating with pneumatic energy or driven by combustion, gas or powder, comprising a nose arranged for being supplied with fixing elements coming from a magazine fixed to the nose, and wherein a sensor is arranged, a fixing element positioned in the nose being driven in the support material through a plunger propelled by the energy of the tools.

It is understood that if the sensor does not withdraw under the action of a fixing element, the operator is faced with a serious problem. This is why it has been attempted to design such fixing tools with the greatest care.

From document EP 0695 605, such a fixing tool is known, having the positioning sensor mounted rotatively on the nose. Such a tool is of an excellent quality, but is difficult to manufacture, and essentially because of the particular mounting of the sensor, the latter is prone to breaking.

Thus, the object of the present application is to provide a fixing tool with a positioning sensor, simple to manufacture and without any risk at the level of the sensor.

Thus, this invention relates to a fixing tool comprising a nose adapted to receive, on the one hand, a fixing element from a fixing element magazine fixed to the nose, and, on the other hand, a fixing element driving piston, propelled by an energy source, a tool positioning sensor being arranged on the nose, characterized in that the sensor comprises a flexible blade arranged on a biasing pad.

The simplicity of the tool sensor according to the invention ensures safety and reliability.

Advantageously, the flexible blade is arranged on the nose with a sliding degree of freedom, so as to be able to withdraw backwards, if necessary.

This invention will be better understood on the basis of the following description of the preferred embodiment of the fixing tool, referring to the accompanying drawing on which:

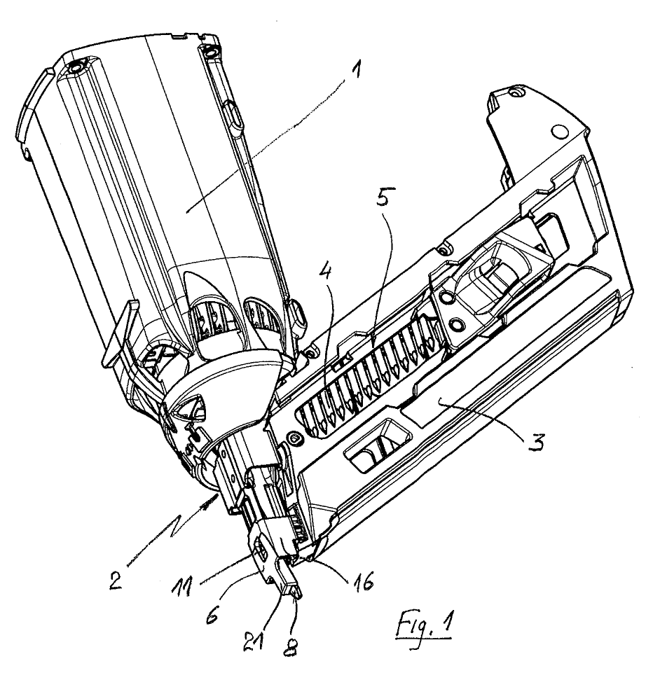

FIG. 1 is a perspective view of the tool;

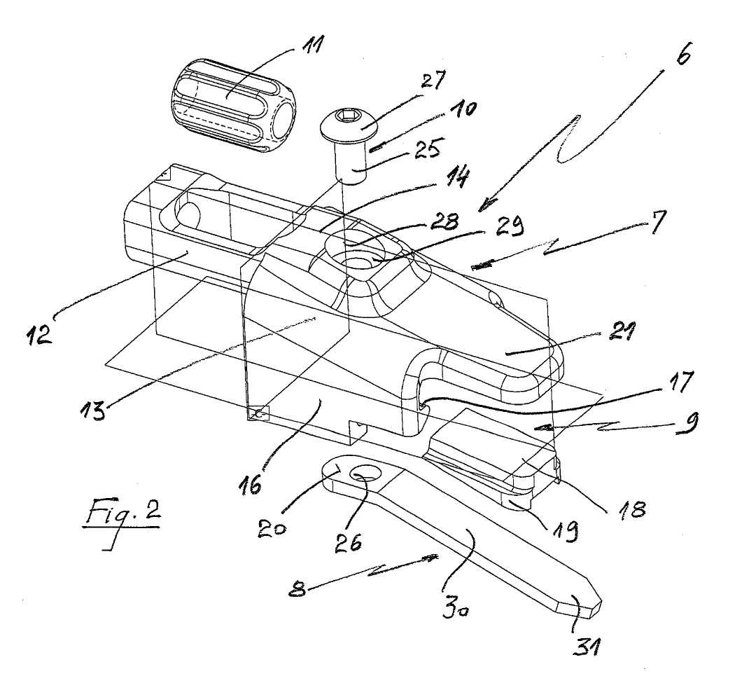

FIG. 2 is an exploded perspective view of the nose shell of the tool in FIG. 1 and of the sensor arranged on the shell;

FIG. 3 is a bottom view of the nose in FIG. 2;

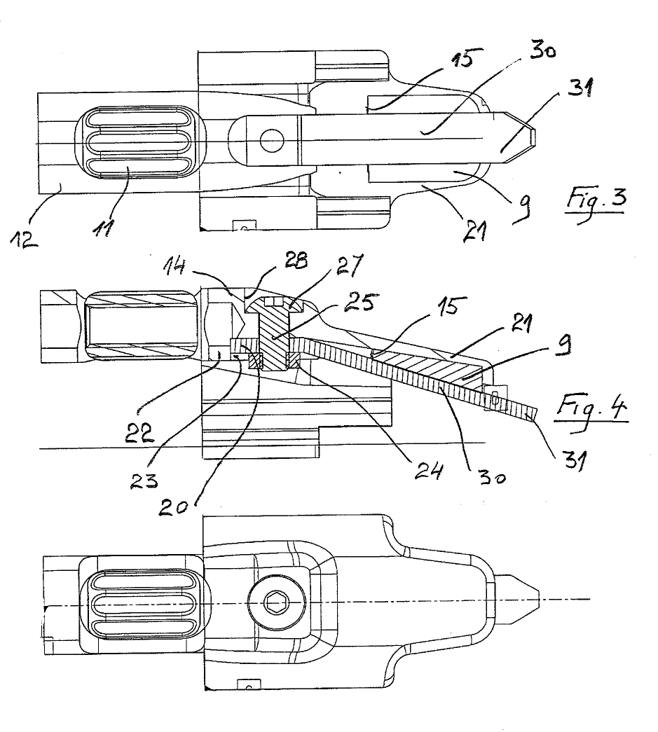

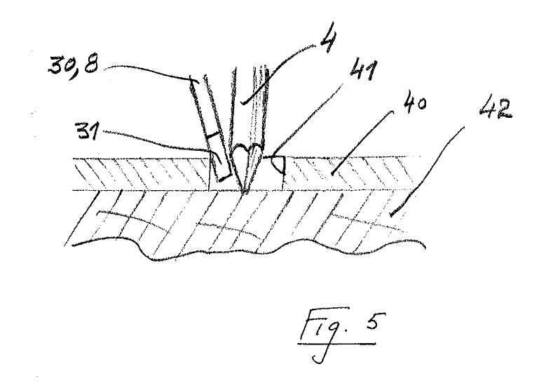

FIG. 4 is an axial sectional view of the nose in FIG. 2 in the mounted state; and

FIG. 5 is a sectional view illustrating the operation of the sensor in the tool of this invention.

The tool, that will be described now, is a nailing device, more precisely provided with gas energy from a gas cartridge, for propelling a nail driving piston into a support material.

The tool comprises an engine housing 1 extended with a nose 2 that is to be applied against the material so as to be able to shoot.

To the nose 2 is fixed a magazine 3 adapted to contain nails 4 being arranged in a strip 5. The magazine comprises members for pushing the strip of nails 5 towards the nose 2 so as to introduce nails 4 one by one into the central bore of the nose 2 adapted for receiving also the piston pushing stem.

A sensor 6 is located at the front end of the nose 2.

The tool, as described up to now, is a conventional tool. The sensor 6 of the tool according to this invention makes it different.

The sensor 6 comprises an external shell 7, a flexible blade 8, a biasing pad 9 and a fixing threaded dowel 10. The sensor also comprises a setting knurl 11.

The shell 7 of the sensor comprises a rear sleeve part 12, of a general parallelipipedic shape, recessed so as to receive the knurl 11 and adapted for fitting onto the tool nose.

As it is known, the knurl 11 is adapted for setting the sensor positioning on the nose and thus for setting the stroke of the driving piston and hence, the penetration depth of the head, of nails into the support material.

The rear sleeve part 12 is extended towards the front by a small front casing 13, with an upper wall 14, a front portion 21 of which, being shaped as a tongue, is slightly recessed inside for forming a housing 15 for receiving the biasing pad 9.

The upper wall 14 is extended by two side flanges 16, at the rear of the tongue 21, being shaped for having two internal edges 17 for sliding and maintaining the sensor on the tool nose 2.

The biasing pad 9 is here made of an elastomer and comprises a central part 18, adapted to be introduced into the casing 15 of the tongue 21 in the upper wall 14 of the sensor casing 13, the central part 18 being extended by two side wings 19 in abutment against the edges of the upper tongue 21 of the casing 13.

The flexible blade 8, here a thin blade, comprises a small perforated front end portion 20 for fixing the blade to the casing 13. There is arranged, inside the rear portion 22 of the upper wall 14 of the casing, a housing 23 for receiving such a portion 20 for fixing the blade 8, being introduced therein slidably and maintained therein by the threaded dowel and a nut 24. The dowel stem 25 extends through the hole 26 of the fixing portion 20 of the blade 8, the nut 24 being arranged on the blade side opposite that being oriented towards the dowel head 27, received in a circular hole 28 arranged in the wall 14. The head 27 is here a six point socket head 32 for being rotationally driven.

The front casing (12) thus supports the flexible blade (8) and the biasing pad (9) thereof.

The fixing portion 20 is extended by a large portion 30 at the sensing end 31, being slightly tilted on such fixing portion.

The nailing device that has just been described is provided for fixing, for example, metallic plates 40, made in pre-perforated metallic sheets, comprising holes, on framework purlins 42.

Before shooting, the sensing end 31 of the flexible blade 8 of the sensor 6 in the tool is placed in a hole 41.

While shooting, because of the recoiling effect, the tool goes out of its support, the sensing end 31 of the blade 8 goes out of the hole 41 of the plate 40 so as to leave room for the nail 4. In any event, and independently of the tool recoil, by virtue of the flexibility in the blade 8 and of the nature of the biasing pad 9, the nail 4, when passing in the sensor pushes the large portion 30 of the blade 8 against the pad 9 which is pressed between the blade and the tongue 21 of the casing 13, before the blade (8) returning to its resting position, both by its own elasticity and by the biasing pad 9.

For providing a better withdrawal of the blade 8 backwards when shooting, a hole could be arranged for receiving the dowel stem, not a circular one as the hole 26, but an oblong one so that the sensing blade 8 is arranged on the shell of the sensor with a sliding degree of freedom.

1. A fixing tool comprising a nose adapted to receive, on the one hand, a fixing element from a fixing element magazine fixed to the nose and, on the other hand, a fixing element driving piston, propelled by an energy source, a sensor for operating the tool being arranged on the nose, wherein the sensor comprises a flexible blade arranged on a biasing pad.

2. A fixing tool according to claim 1, wherein the sensor comprises a rear part for fitting onto the nose and a front casing supporting the flexible blade and the biasing pad.

3. A fixing tool according to claim 2, wherein the flexible blade is fixed to the casing by a dowel driven through a hole arranged in the blade.

4. A fixing tool according to claim 1, wherein the flexible blade is arranged on the tool nose with a sliding degree of freedom.
